(19) United States
(12) Patent Application Publication
(10) Pub. No.: US 2016/0153375 A1
(43) Pub. Date: Jun. 2, 2016

(54) METHOD FOR OPERATING AN ENGINE

(71) Applicant: GENERAL ELECTRIC COMPANY, Schenectady, NY (US)

(72) Inventor: Adam Edgar Klingbeil, Ballston Lake, NY (US)

(21) Appl. No.: 15/013,432

(22) Filed: Feb. 2, 2016

Related U.S. Application Data
(63) Continuation-in-part of application No. 13/484,821, filed on May 31, 2012, now Pat. No. 8,959,429.

(51) Int. Cl. F02D 41/00; F02D 19/08

(52) U.S. Cl. CPC F02D 41/0027; F02D 19/081; F02D 41/0025

(57) ABSTRACT

A method of operating an internal combustion engine, where the internal combustion engine comprises a first cylinder set and a second cylinder set, comprises: introducing multiple fuels and an oxidant into the first cylinder set at a first substitution rate; introducing multiple fuels and an oxidant into the second cylinder set at a second substitution rate; monitoring an engine parameter(s); and then adjusting the first substitution rate to a third substitution rate in one (or more) cylinder of the first cylinder set, in response to the monitoring, such that the third substitution rate is different than the second substitution rate.

### CROSS REFERENCE TO RELATED APPLICATIONS

This Continuation In Part Application claims benefit of priority to commonly assigned U.S. patent application Ser. No. 13/484,621, filed May 31, 2012, entitled METHOD FOR OPERATING AN ENGINE (Attorney Docket No. 255300-1). The contents of which are incorporated herein by reference in its entirety.

### BACKGROUND OF THE DISCLOSURE

This invention relates generally to methods for operating an engine. More particularly, this invention relates to methods for introduction of a plurality of fuels into an internal combustion engine for operating such an engine.

Internal combustion engines have been widely used in many fields, such as vehicles due to high power-to-weight ratios together with high fuel energy density. In recent years, with increasing attention of reducing pollution of harmful engine emissions to environment, internal combustion engines, such as compression ignition engines (also known as “diesel” engines) can be modified to burn a plurality of fuels, such as both natural gas and diesel fuels, which is referred to as dual fuel operation.

During some types of dual fuel operation, the natural gas may be premixed with an intake air, and then the mixture is introduced into engine cylinders during intake strokes thereof. Subsequently, compression strokes of the engine cylinders start and proceed to increase pressure and temperature of the mixture. At the end of the compression strokes, a small quantity of the diesel fuel is injected into the engine cylinders to ignite the mixture of the intake air and the natural gas by the auto-ignition of the diesel fuel so as to trigger combustion in the engine cylinders.

As a result, the substitution of the natural gas for the diesel fuel can reduce the emissions of the pollutants, such as nitrogen oxides (NOₓ), and particulate matter (PM). However, when the operation of such engines is switched from a steady state to an increased load state, such as a transient acceleration state, the quantity of the natural gas is increased significantly to provide desirable power, which results in reduction of the air fuel ratio (AFR) and may cause the auto-ignition of the premixed natural gas accordingly. The auto-ignition of the premixed natural gas may cause detonation or knocking in the engine cylinders, thereby damaging the engine.

There have been attempts to avoid the detonation or knocking in the engine cylinders. For example, to enable the dual fuel operation, the compression ratio of the engine cylinders may be reduced. This may result in reduction of the cycle efficiency of the engines and increased challenges during cold start. Alternatively, during the dual fuel operation, the substitution of the natural gas to the diesel fuel may be reduced, which increases the harmful engine emissions and the fuel cost due to the increased quantity of the diesel fuel.

Additionally, sudden increases in laod may result in increased temperature of an aftertreatment system. If the aftertreatment system has built up flammable substances (e.g., oil, unburned fuel, or soot particles), uncontrolled combustion in the aftertreatment system may occur, thereby causing damage to the aftertreatment system.

Attempts to avoid uncontrolled oxidation in the aftertreatment have primarily looked to limiting the rate of load increase. However, this can result in degraded performance when fast load increase is desired.

Therefore, there is a need for new and improved methods for operating an internal combustion engine.

### BRIEF DESCRIPTION

A method for operating an engine is provided in accordance with one embodiment of the invention. The method comprises introducing a first fuel, a second fuel and an oxidant into a first engine cylinder and a second engine cylinder; monitoring a plurality of engine parameters; and adjusting a quantity of one of the first fuel, the second fuel, and the oxidant introduced to the first engine cylinder to be different from a quantity of one of the firs fuel, the second fuel, and the oxidant introduced to the second engine cylinder based at least one of the plurality of monitored engine parameters.A method for operating an engine is provided in accordance with another embodiment of the invention. The method comprises introducing a first fuel, a second fuel and an oxidant into a first engine cylinder to operate the engine; monitoring a plurality of engine parameters; and increasing a quantity of the second fuel introduced in the first engine cylinder based on one of the plurality of monitored engine parameters; and reducing a quantity of the first fuel introduced in the first engine cylinder based on one of the plurality of monitored engine parameters in response to an increased load operation of the engine.

A method for operating an engine is provided in accordance with yet another embodiment of the invention. The method for operating an engine, comprises introducing a first fuel, a second fuel and an oxidant into a first engine cylinder set and a second engine cylinder set; monitoring a plurality of engine parameters; increasing a quantity of the second fuel and reducing a quantity of the first fuel in the first engine cylinder set in response to an increased load operation of the engine; and adjusting a quantity of one of the first fuel, the second fuel and the oxidant introduced to the second engine cylinder set to be different from a quantity of one of the first fuel, the second fuel, and the oxidant introduced to the first engine cylinder set.

A method for operating an internal combustion engine is provided in accordance with yet another embodiment of the invention. The method of operating an internal combustion engine, said internal combustion engine comprising a first cylinder set and a second cylinder set, the method comprises: introducing a first fuel, a second fuel, and an oxidant into the first cylinder set, thereby defining a first substitution rate; introducing a first fuel, a second fuel, and an oxidant into the second cylinder set, thereby defining a second substitution rate; monitoring at least one engine parameter; and adjusting the first substitution rate to a third substitution rate in at least one cylinder of the first cylinder set, in response to the monitoring, wherein the third substitution rate is different than the second substitution rate.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of an engine cylinder of an engine in accordance with one embodiment of the invention;

FIG. 2 is a schematic diagram of a system for operating an engine in accordance with one embodiment of the invention; and

FIG. 3 is a schematic flow chart showing operation of the engine in accordance with one embodiment of the invention.

### DETAILED DESCRIPTION

Preferred embodiments of the present disclosure will be described hereinbelow with reference to the accompanying drawings. In the following description, well-known functions or constructions are not described in detail to avoid obscuring the disclosure in unnecessary detail.

In embodiments of the invention, a method for operating an engine is provided. The engine may comprise an internal combustion engine or other types of engines. Typically, the method employs a plurality of fuels to operate the engine. In one non-limiting example, the method is provided to operate the engine to switch from a steady state to an increased load state. As used herein, in some applications, the term “steady state” may indicate engine load or engine speed is substantially stable.

The fuels at least comprise a first fuel and a second fuel. The first and second fuels comprise a non-compression-combustible fuel and a compression-combustible fuel, respectively. As used herein, the term “non-compression-combustible fuel” means any single material or combination of materials that will not spontaneously ignite or combust under typical operating conditions, but will ignite or burn with the aid of an ignition spark or flame in a reciprocating engine cylinder.

It is known to one skilled in the art that most fuels will be compression-combustible at sufficiently high temperatures, but the non-compression-combustible fuels referred to here are fuels that are intended to ignite via flame propagation only and that auto-ignition or compression-combustion be avoided. Non-limiting examples of such fuels include natural gas, ethanol or gasoline.

The term “compression-combustible fuel” means any single material or combination of materials that are intended to spontaneously ignite or combust, without the aid of an ignition spark or existing flame, in a reciprocating engine cylinder during and/or immediately after a compression stroke of a piston therein. Non-limiting examples of the compression-combustible fuels include diesel, kerosene and heavy fuel oil.

During the increased load state of the engine, the quantity of the first fuel may be reduced and the quantity of the second fuel is increased for introduction into a cylinder of the engine, as compared to operation in the steady state thereof, such that the total fuels into the engine is increased. In some examples, the quantity of the first fuel is decreased to be in a range of from about 70% to about 50% and the quantity of the second fuel is increased to be in a range of from 30% to about 50%.

The term “substitution rate” as used herein means the relative quantity of non-compression-combustible fuel to the total fuel used in the combustion chamber during an engine cycle.

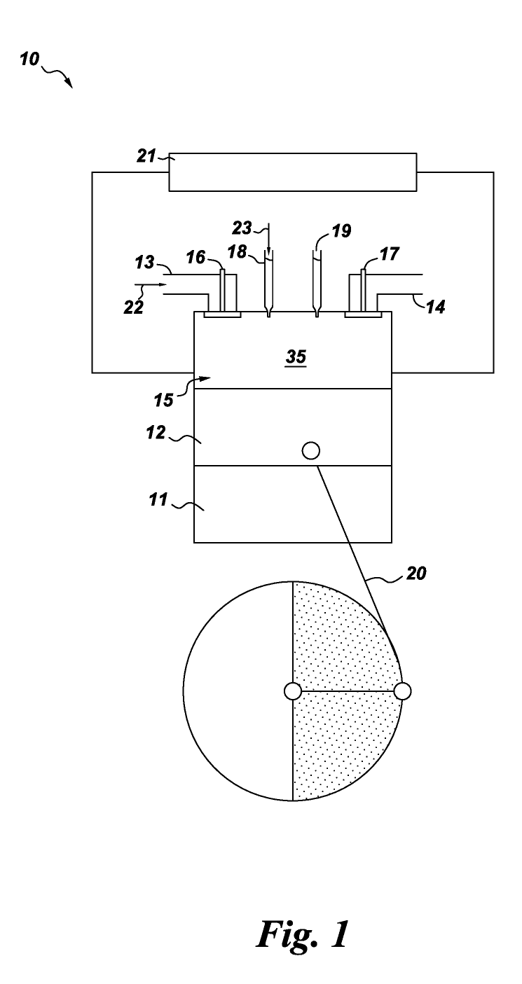

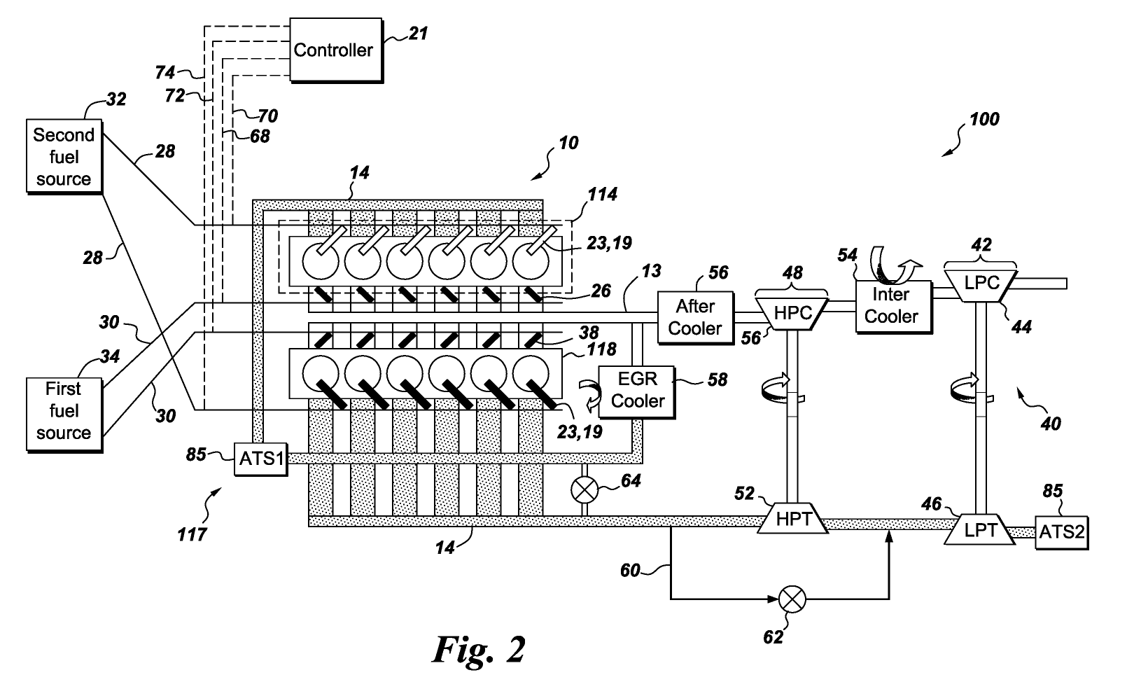

FIG. 1 illustrates a schematic diagram of a cylinder 11 of an engine 10 in accordance with one embodiment of the invention. Although a single cylinder 11 of the engine 10 is illustrated, the engine 10 may comprise more than one cylinder, for example four, six, eight, or twelve cylinders cooperating to provide suitable power based on different applications. See e.g., FIG. 2. For ease of illustration, other elements, such as sensors and sealing elements are not illustrated in FIG. 1.

As illustrated in FIG. 1, the engine 10 comprises the cylinder 11 having a piston 12 movably located therein. An intake manifold 13 and an exhaust manifold 14 are in fluid communication with a combustion chamber 15 defined within the cylinder 11, respectively. The intake manifold 13 is configured to provide an input pathway (not labeled) for introduction of an oxidant and a first fuel into the combustion chamber 15. Alternatively, the intake manifold 13 is configured to provide an input pathway (not labeled) for introduction of only an oxidant from the intake manifold 13 into the combustion chamber 15 (i.e., the first and second fuel are injected directly into the combustion chamber 15). The exhaust manifold 14 is configured to provide an output pathway (not labeled) for all products of a combustion event that takes place in the combustion chamber 15.

A plurality of valves, such as an intake valve 16 and an exhaust valve 17 are configured to actuate at certain times and for certain durations to open and close fluid pathways (not labeled) between the combustion chamber 15 and the respective intake manifold 13 and the exhaust manifold 14. Additionally, one or more injectors, such as first and second injectors 18, 19 are also in fluid communication with the combustion chamber 15 so as to provide at least one fuel into the combustion chamber 15. Second injector 19 may provide a second fuel or also provide a first fuel. It should be clear to one skilled in the art that any of the injectors may be in direct communication with the combustion chamber or may only be in fluid communication with the combustion chamber through a manifold such as the intake manifold or via a prechamber

A connecting rod 20 is disposed between and connecting the piston 12 and a transmission mechanism, such as a crank shaft (not shown) so as to transmit the translational mechanical energy generated by the engine 10 into rotational energy for further use.

In addition, the engine further comprises a control unit 21 configured to control operation or status of the engine based on outputs from a plurality of sensors (not shown). The sensors are configured to monitor or detect a plurality of (measured or monitored) engine parameters including pressures, temperatures, flow rates, speed and power so that the control unit 21 determines and controls other parameters including, but not limited to fuel injection timings and quantities for all fuels being introduced accordingly.

Non-limiting examples of the plurality of sensors include fuel injection timing sensors, fuel flow sensors, throttle position sensors, manifold air pressure sensors, manifold air temperature sensors, exhaust gas temperature sensors, engine power sensors, knock sensors or the like. Thus, in non-limiting examples, the measured engine parameters may comprise at least one of engine speed, engine load, engine throttle position, intake manifold temperature, intake manifold pressure, exhaust gas flow rate and temperature, air flow into the cylinder, compression ratio, intake and exhaust valve timing.

In other embodiments, examples of other engine parameters may comprise a status of one or more sensors. For example, a measured engine parameter may comprise if a particular sensor (e.g., knock sensor, temperature sensor, etc.) is broken or not operating correctly.

In still another embodiment, another engine parameter may comprise an aftertreatment status. The aftertreatment status may comprise temperature, flow, and/or pressure drop of a predetermined quantity, whether the aftertreatment is regenerating, measured engine operation over time, anticipated regeneration start event, estimated collection of flammable substances in the aftertreatment system, and the like.

Generally, during operation of a so-called four-stroke engine, each cylinder, such as the cylinder 11 of the engine 10 typically undergoes a four stroke cycle including an intake stroke, a compression stroke, an expansion stroke, and an exhaust stroke. As referred to FIG. 1, during the intake stroke, the exhaust valve 17 closes and the intake valve 16 opens. A mixture 22 is introduced into the combustion chamber 15 through the intake manifold 13 while the piston 12 moves towards a bottom of the cylinder 11 to increase the volume within the combustion chamber 15 until the piston 12 moves to a position where the combustion chamber 15 is at its largest volume, which is typically referred to as a bottom dead center (BDC) to complete the intake stroke. It will be apparent to one skilled in the art that this invention is not limited to a four-stroke engine and will work for other types of engines such as two-stroke engines and rotary engines, for example.

For the illustrated arrangement, the mixture 22 comprises the first fuel, such as the natural gas and at least one oxidant. In non-limiting examples, the at least one oxidant comprises air, pure oxygen, or either of which may be mixed with re-circulated exhaust gas. Prior to introduction of the mixture 22 into the combustion chamber 15, the at least one oxidant and the first fuel are premixed. In one non-limiting example, the premixing may take place in the intake manifold 13. Due to the employment of the control unit 21, the quantities and/or premixing of the first fuel and the at least one oxidant may be controlled based on the detected engine parameters.

As used herein, the term “premixed” means increasing the level, degree, and/or factor of homogeneity of two, or more, substances prior to an event. By example only, the air and the first fuel may be premixed to generate the premixed mixture 22 prior to the combustion event such that the level or degree homogeneity of the air and the first fuel has increased. Once the mixture 22 enters the combustion chamber 15 it may defined as a second mixture 35.

In an alternative embodiment, the mixture 22 may comprise only one or more oxidants being introduced into the combustion chamber 15 from the intake manifold 13, wherein the first and second fuel are injected directly into the combustion chamber 15 via one or more injectors (e.g., 19, 23).

As used herein, the term “combustion event” means the activities occurring when a fuel(s)/air mixture is ignited and/or burned, partially or entirely, in a combustion chamber of an engine, thereby producing heat, carbon dioxide, steam, and other chemicals, regardless of whether the event was via spark ignition, compression ignition, or other suitable means.

Subsequently, during the compression stroke, the intake valve 16 and the exhaust valve 17 are closed. The piston 12 moves towards the cylinder head (not labeled) so as to compress the mixture 35 within the combustion chamber 15. The position at which the piston 12 is at the end of this stroke when the combustion chamber 15 is at its smallest volume is typically referred to as top dead center (TDC).

At the end of the compression stroke, in one non-limiting example, a certain quantity or amount of the second fuel 23 is controlled by the control unit 21 to be directly injected into the combustion chamber 15 via one or more of the injectors 18, 19. Alternatively, the second fuel 23 may be injected into the combustion chamber 15 before the piston 12 moves to the top dead center of the compression stroke.

In this compression stroke, because the mixture 35 is leaner than stoichiometric, the first fuel, such as the natural gas in the mixture 35 may not be prone to auto-ignition. Due to the compression-combustible property, the second fuel 23 may be prone to ignite upon injection into the combustion chamber 15, thereby igniting the mixture 35 of the air and the natural gas so as to trigger combustion accordingly.

As used herein, the term “lean” means a fuel(s)/oxidant(s) mixture having more oxidant(s) than the amount of oxidant(s) required at the stoichiometric point for the particular mixture. The term “stoichiometric” means a fuel(s)/oxidant(s) mixture having exactly enough oxidant(s) required to convert all of the fuel(s) to primary combustion products (e.g., CO₂ and H₂O for hydrocarbon fuels).

Next, during the expansion stroke, due to the combustion, expanding gases generated during the combustion push the piston 12 back to BDC. The connecting rod 20 converts the movement of the piston 12 into the rotational energy for further use. Finally, during the exhaust stroke, the exhaust valve 17 opens to release the combusted air-fuel mixture through the exhaust manifold 14 and the piston 12 returns to TDC.

It should be noted that the above operation is merely illustrated as an example. In some examples, instead of injection of the second fuel 23 during the compression stroke, the mixture 22 and the second fuel 23 may be introduced into the combustion chamber 15 to mix together over time therein during the intake stroke prior to any combustion so that the degree of homogeneity of the mixture 35 and the second fuel 23 increases. Subsequent to the mixing, the second fuel 23 is combusted via compression of the piston 12 during the compression stroke.

During operation of the engine 10, the control unit 21 controls the engine operation based on the monitored engine parameters. Based on the monitoring of the parameters of the engine 10, when the engine is detected to operate, for example, in a steady state, the ratio of the first fuel, such as the natural gas to the second fuel, such as the diesel, is high and stable, and reduces the emissions of pollutants.

However, as mentioned above, in some current applications, when the engine operates to respond to a transient condition such as an increased load state (or operation) including the transient acceleration state, typically to switch from a steady state to a transient acceleration state, the quantity of the natural gas may be controlled to increase to a certain amount to provide desirable power. As a result, this causes reduction of the overall air to fuel ratio (AFR) and may cause the auto-ignition of the premixed natural gas during the compression stroke. The premixed natural gas burns volumetrically and may cause detonation or knocking issues in the engine.

Accordingly, in embodiments of the invention, compared to the operation in the steady state, when the engine operates in the increased load state, the quantity of the first fuel may be reduced and the quantity of the second fuel may be increased. Since the second fuel ignites upon injection and thus may not burn volumetrically so that the detonation or knocking issues may be avoided or eliminated.

For some arrangements, during the operation of the engine to respond to the transient requirements such as the increased load state, a first cylinder of the engine may act as a transient cylinder to respond to the increased load condition by decreasing the amount of the first fuel, increasing the amount of the second fuel and increasing the overall fuel rate to generate more power. A second cylinder of the engine may act as a base-load cylinder which operates with a substantially constant ratio of the first fuel to the second fuel, for example in a steady state or adjusting the fuel rate gradually as the air flow or other monitored parameters change.

In some applications, the base-load cylinder may have different operation conditions from the transient cylinder so as to respond slowly to the increased load operation than the transient cylinders. In some examples, a quantity of one of the first fuel, the second fuel, and the oxidant introduced to the first engine cylinder is different from a quantity of one of the first fuel, the second fuel, and the oxidant to the second cylinder based on one or more of the monitored engine parameters. For example, the quantity of the first fuel in the base-load (second) engine cylinder is greater than the quantity of the first fuel in the transient (first) engine cylinder, and the quantity of the second fuel in the base-load engine cylinder is smaller than the quantity of the second fuel in the transient engine cylinder during responding to the increased load operation. As used herein, “one” means one or more. After finishing the increased load operation, the base-load cylinder and the transient cylinder may operate in a similar or an identical steady state mode.

In the transient cylinder, the control unit 21 may control such that the first fuel for introduction therein may be in a range of from about 50% to about 70% of total energy content therein. In one example, the first fuel for introduction may be about 60% of the total energy content therein. In the steady state, the ratio of the first fuel to the second fuel may not vary in the corresponding cylinders, for example may be equal for all of the cylinders of the engine.

FIG. 2 schematically illustrates an exemplary system 100 for operating an engine 1 in accordance with an embodiment. The engine 10 may include a donor cylinder set 114 having multiple donor cylinders coupled to an intake manifold 13 that is configured to feed a flow of air to the donor cylinder set 114. The engine 10 may also include a non-donor cylinder set 118 coupled to the intake manifold 13 and an exhaust manifold 14. The intake manifold 13 is further configured to feed air to the non-donor cylinder set 118. The engine 10 also includes an exhaust channel 14 extending from the donor cylinder set 114 to the intake manifold 13 for recirculating an exhaust emission in an exhaust gas recirculation (EGR) loop 117 from the donor cylinders to both donor cylinders 114, and non-donor cylinders 118 via the intake manifold 13.

Further each cylinder of the donor cylinder set 114 includes a second direct injector 19, 23 that injects a second fuel 28 from a second fuel source 32. The system 100 also includes a first port injector 26 disposed in each of a plurality of first intake passages configured to inject a first fuel 30 from a first fuel source 34. Similarly, each cylinder of the non-donor cylinder set 118 may also include a third direct injector 19, 23 and a fourth port injector 38. The third direct injector 19, 23 injects the second fuel 28 from the second fuel source 32, while the fourth port injector 38 disposed in each of a plurality of second intake passages 39, injects the first fuel 30 from the first fuel source 34. In one embodiment, the second fuel 28 includes a diesel fuel. The first fuel 30 may include at least one of natural gas, nitrogen, hydrogen, syngas, gasoline, ethanol, carbon monoxide, propane, biogas, liquid petroleum gas (LPG).

Furthermore, the system 100 may include a two-staged turbocharger 40 configured to provide compressed air to the dual fuel engine 10 through the intake manifold 13. The two-staged turbocharger 40 includes a first stage turbocharger 42 that includes a low pressure compressor 44 and a low pressure turbine 46. The two-staged turbocharger 40 also includes a second stage turbocharger 48 having a high pressure compressor 50 and a high pressure turbine 52. As shown in FIG. 2, the low pressure compressor 44, the high pressure compressor 50 and the intake manifold 13 are in fluid communication with each other. Ambient air is routed through the low pressure compressor 44 and the high pressure compressor 50 for sufficient compression prior to being directed into the intake manifold 13. The flow of air is cooled in two stages in an intercooler 54 located between the compressors 44, 50 and in an aftercooler 56 located between the high pressure compressor 50 and the intake manifold 13. The exhaust emissions in the exhaust gas recirculation loop 117 are also cooled in an EGR cooler 58 prior to being directed into the intake manifold 13. In one embodiment, each of the intercooler 54, aftercooler 56 and the EGR cooler 58 is a heat exchanger that may utilize a fluid for extracting heat thereby cooling the flow of air and exhaust emissions flowing through each of the cooler. The exhaust emissions flowing out of the non-donor cylinder group 118 through the exhaust manifold 14 are routed through the high pressure turbine 52 and the low pressure turbine 46 prior to being released out of the system 100. As shown in FIG. 2, the high pressure turbine 52 and the low pressure turbine 46 are driven by the force of the exhaust emissions and in turn drive the high pressure compressor 50 and the low pressure compressor 42 respectively. In one embodiment, the system 100 includes a high pressure turbine (HPT) bypass line 60 having a valve 62 that may be operated to route the exhaust emissions directly through the low pressure turbine 46 bypassing the high pressure turbine 52. In another embodiment, the system 100 also includes a valve 64 located in a fluid line connecting the EGR loop 117 and the exhaust manifold 14 for controlling flow of exhaust emissions in the EGR loop 117. In a non-limiting example, the system 100 may include a single staged turbocharger (not shown) configured to provide compressed air to the dual fuel engine 10 through the intake manifold 13.

The system 100 also includes a controller 21 e.g., an electronic control unit (ECU), coupled to various sensors and components throughout the system 100. As shown, the controller 21 includes electrical connections 68, 72 and 74 that are coupled with fuel lines that supply the second fuel 28 and first fuel 30 to the donor cylinder group 114 and the non-donor cylinder group 118. Thus, the controller 21 is configured to, during a single engine cycle, operate the first direct injector 19, 23 and the second port injector 26, the third injector 19, 23 and the fourth port injector 38 in each of the donor cylinder set 114 and the non-donor cylinder set 118 respectively, such that there is a higher fraction of injection of the second fuel into the donor cylinder set in comparison to the second fuel being injected into the non-donor cylinder set and a lower fraction of injection of the first fuel into the donor cylinder set in comparison to the first fuel being injected into the non-donor cylinder set. This operation of differential fueling reduces the risk of knock in the donor cylinder set 114 while maintaining a required power output. In one non-limiting example, a quantity of the second fuel injected into the donor cylinder set 114 is about 40 percent of a total fuel combusted in the donor cylinder set 114, while a quantity of the second fuel injected into the non-donor cylinder set 118 is about 14 percent of a total fuel combusted in the non-donor cylinder set 118. This allows more consumption of the first fuel 30 and thereby, resulting in economical operation of the engine 10. This operation of differential fueling is carried out during high load or high ambient temperature conditions. The dual fuel engine 10 is also configured to operate such that the quantity of the second fuel injected into the donor cylinder set 114 may vary from about one percent to about 100 percent.

Moreover, in one embodiment, during low power load conditions or low ambient temperature conditions, the controller 21 is configured to operate the first direct injector 19, 23 and the second port injector 26 in the donor cylinder set 114 at an optimal second fuel injection timing so as to obtain higher substitution rate of the second fuel 28 as compared to substitution rate of the second fuel 28 in the non-donor cylinder set 118. Further, the terms ‘substitution rate’ to each cylinder in the donor cylinder set may be defined as a ratio of first fuel 30 supply to a total fuel. This causes generation of emissions from the donor cylinder set with increased amounts of carbon monoxide. The recirculation of the emissions having increased amounts of carbon monoxide from the donor cylinder set 114 to the non-donor cylinder set 118 and the donor cylinder set 114 for further oxidizing the carbon monoxide. It is to be noted that operating the injectors 19, 23, 26 at optimal second fuel injection timing so as to obtain high substitution rate of the second fuel 28 per the first fuel 30 in each cylinder of the donor cylinder set 114 is carried out at low power or low ambient temperature conditions. In another embodiment, at low power or low ambient temperature conditions, each non-donor cylinder of the non-donor cylinder set 118 may be operated at lower substitution rate in order to control emissions, while donor cylinder set 114 may be operated at high substitution rate. It is to be understood that the terms ‘substitution rate’ to each cylinder in the non-donor cylinder group may be defined as a ratio of first fuel 30 supply to a total fuel supply.

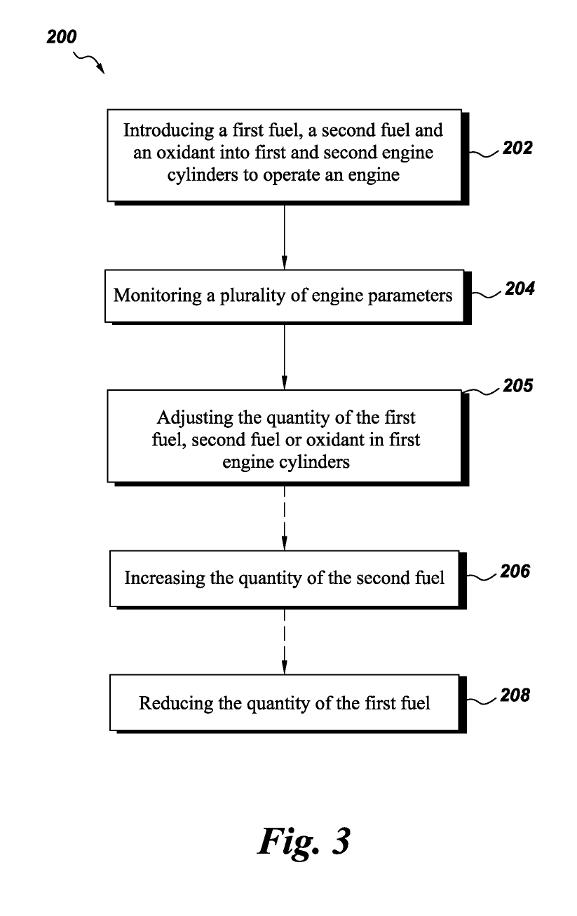

FIG. 3 is a schematic diagram of the method 200 for introduction of the first and second fuels into a first engine cylinder when the engine operates in the increased load state. It should be noted that the arrangement in FIG. 3 is merely illustrative. As mentioned above, more than one engine cylinder may be employed and the more than one engine cylinder may comprise a transient engine cylinder (a first engine cylinder) and a base-load engine cylinder (a second engine cylinder).

As illustrated in FIG. 3, in step 202, introducing a first fuel, a second fuel and an oxidant into the first engine cylinder to operate an engine. In step 204, monitoring a plurality of engine parameters. At step 205, adjusting a first fuel, a second fuel, and/or an oxidant in the first cylinder, based on the monitored engine parameters.

Subsequently, optionally in step 206, based on one or more of the monitored engine parameters, increasing the quantity of the second fuel to be in a range of from about 30% to about 50% of total energy content for introduction into the first engine cylinder. Meanwhile, optionally in step 208, reducing the quantity of the first fuel to be in a range of from about 50% to about 70% in the first engine cylinder.

In some applications, after the increased load operation of the engine finishes, the engine may be controlled to operate in the previous or another steady state, and the ratio of the first fuel to the second fuel is increased and stable accordingly. In some examples, the sequences of introducing the fuels into the cylinder and monitoring the engine parameters may be the same or different. The sequences of the steps 206 and 208 may also be the same or different.

In embodiments of the invention, the ratio of the first fuel to the second fuel is adjusted in some cylinders in response to the engine operation conditions. For example, in the transient acceleration operation, the quantity of the second fuel is increased and the quantity of the first fuel is reduced so as to avoid detonation or knocking issues generated in the engine. At the same time, the total amount of the fuels (for example, the total quantities of the first fuel and the second fuel) supplied is increased to increase the power level.

In addition, the method for operating the engine in response to the transient acceleration condition is relatively simple to retrofit the conventional engines. In certain applications, the method may be used in response to not only the transient acceleration operation but also other transient operations. Non-limiting examples of the transient operation include the operations switched from respective steady states.

The individual cylinders may further be adapted as needed, based on their purpose. For example, the cylinders that are accepting the transient fueling may be equipped with different compression ratio, different valve lift profiles, different sensors or different hardware configurations than the base load cylinders. In some applications, differences of the hardware configurations between the transient cylinders and the respective base load cylinders may comprise one of a valve event, compression ratio, piston, piston ring, valve lift profile, pressure sensor, temperature sensor, knock sensor, injector or injector nozzle.

Commonly assigned U.S. patent application Ser. No. 14/515,992 entitled DIFFERENTIAL FUELING BETWEEN DONOR AND NON-DONOR CYLINDERS IN ENGINES (attorney docket no. 272349-1) describes the use of donor and non-donor cylinders as it relates to engine gas recirculation (EGR). The reference is incorporated herein in its entirety.

In other embodiments, the individual cylinders of the engine may comprise a first set and a second set of cylinders wherein the first set is for transient fueling and the second set is for non-transient fueling. The first set may comprise all non-donor cylinders while the second set may comprise donor cylinders. The quantity of cylinders in the first and second set may be equal. In other embodiments, the quantity of cylinders may be different.

In an embodiment, a first and second fuel and oxidant are introduced into a first cylinder set, thereby defining a first substitution rate, while first and second fuel and oxidant are introduced into a second cylinder set, thereby defining a second substitution rate. Various engine parameters are monitored continually or periodically. In response to the engine parameter monitoring, the controller adjusted the first substitution rate in one or more (or all) of the cylinders in the first cylinder set to a third substitution rate that is different than the second substitution rate. The third substitution rate typically is less than the first substitution rate. In an embodiment, the first cylinder set may comprise non-donor cylinders and the second cylinder set may comprise donor cylinders. In another embodiment, the first cylinder set may comprise donor cylinders and the second cylinder set may comprise non-donor cylinders.

In another embodiment, the third substitution rate may be less than the first substitution rate. In an example of this embodiment, the third substitution rate may comprise turning off all first fuel in a single cylinder in the case where a status of a sensor to a cylinder is detecting to not be working (e.g., knock sensor). For example, if a knock sensor for one (or more) cylinder is not working, all natural gas to that particular (or more than one) cylinder is turned off

In still another embodiment, a monitored engine parameter may comprise ambient temperature. During cold operations (e.g., ambient temperature being below a predetermined threshold), the third substitution rate may be greater than the first substitution rate in the situation where the first cylinder set comprises donor cylinders. For example, during cold operation, the controller can call for an increase in natural gas being introduced into the donor cylinders. One benefit is increased HC or CO emissions that can be oxidized in the non-donor cylinders.

Also during cold ambient and/or cold engine start up conditions an embodiment can advance in the donor cylinders and/or retard timing the non-donor cylinders. In this manner, the non-donor cylinders, having retarded timing, can assist in heating up the exhaust more quickly, so as to activate the aftertreatment system.

In still another embodiment, a monitored engine parameter may comprise either measured or calculated status of an aftertreatment where the aftertreatment system may suffer damage as a result of a sudden increase in temperature beyond a limited temperature (e.g., temperature point, rate of rise, etc.). This may be in conjunction with extended idle or cold operation. For example, the status of the aftertreatment may be that the aftertreatment has accumulated a large amount of flammable material including oil, unburned fuel, and/or particulate. Alternatively, the status of the aftertreatment may be that it is at a relatively low temperature and would suffer from extreme thermal stresses in the event of a sudden increase in temperature. In this embodiment, the fueling may be adjusted such that the temperature of the aftertreatment is controlled to prevent damage.

In a multicylinder engine system with aftertreatment, exhaust from some of the cylinders is fed to an aftertreatment system, while exhaust from other cylinders is not fed to the aftertreatment system. In a donor cylinder engine system, either the set of donor or non-donor cylinders may pass exhaust through an aftertreatment system, while the other set of non-donor or donor cylinders do not pass exhaust through the aftertreatment system. Alternatively, in a multicylinder engine, some cylinders may exhaust directly to the atmosphere while other cylinders exhaust to an aftertreatment system. In this case, the cylinders that exhaust to the aftertreatment system may be operated to minimize exhaust temperature and unburned or partially burned fuel if the status of the aftertreatment system indicates that this could result in an unacceptable rise in temperature. See e.g., FIG. 2 wherein one or more aftertreatment systems 85 (labelled “ATS1” and “ATS2”) may be situated in the system 100. For example, an aftertreatment system 85 (ATS1) may be located after the donor cylinders only. In an alternative embodiment, an aftertreatment system 85 (ATS2) may be located only after the low pressure turbine 46. In still another embodiment, both aftertreatment systems 85 (ATS1, ATS2) may be located after the donor cylinders and after the low pressure turbine 46.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A method for operating an engine, comprising:
introducing a first fuel, a second fuel and an oxidant into a first engine cylinder and a second engine cylinder;
monitoring a plurality of engine parameters; and
adjusting a quantity of one of the first fuel, the second fuel, and the oxidant introduced to the first engine cylinder to be different from a quantity of one of the first fuel, the second fuel, and the oxidant introduced to the second engine cylinder based on at least one of the plurality of monitored engine parameters.

2. The method of claim 1, wherein adjusting comprises reducing the quantity of the first fuel and increasing the quantity of the second fuel introduced into the first engine cylinder.

3. The method of claim 2, wherein the quantity of the first fuel is decreased to be in a range of from about 70% to about 50% of total energy content in the first engine cylinder, wherein the quantity of the second fuel is increased to be in a range of from 30% to about 50% of the total energy content in the first engine cylinder.

4. The method of claim 2, wherein increasing the quantity of the second fuel and reducing the quantity of the first fuel is in response to an increased load operation of the engine.

5. The method of claim 4, wherein the quantity of the first fuel in the first engine cylinder is smaller than the quantity of the first fuel in the second engine cylinder, and wherein the quantity of the second fuel in the first engine cylinder is greater than the quantity of the second fuel in the second engine cylinder.

6. The method of claim 4, wherein the increased load operation of the engine comprises a transient acceleration operation.

7. The method of claim 1, wherein the first fuel comprises a gaseous fuel and wherein the second fuel comprises a liquid fuel.

8. The method of claim 7, wherein the first fuel comprises natural gas, wherein the second fuel comprises diesel, and wherein the oxidant comprises air.

9. The method of claim 1, wherein the plurality of the engine parameters comprise one of engine load and engine speed.

10. The method of claim 1, wherein introducing comprises introducing a pre-mixture of the first fuel and the oxidant into the first engine cylinder during an intake stroke thereof and introducing the second fuel into the first engine cylinder during a compression stroke thereof.

11. The method of claim 1, wherein a quantity of the first engine cylinder is less than a quantity of the second engine cylinder.

12. The method of claim 11, wherein the quantity of the first engine cylinder is one.

13. The method of claim 1, wherein the first engine cylinder has a first hardware configuration, wherein the second engine cylinder has a second hardware configuration, further wherein the first and second hardware configurations are different.

14. The method of claim 13, wherein the difference of the first and second hardware configurations comprise one of a valve event, compression ratio, piston, piston ring, valve lift profile, pressure sensor, temperature sensor, knock sensor, injector and injector nozzle.

15. The method of claim 1, wherein one of the plurality of engine parameters comprises an aftertreatment status.

16. The method of claim 1, wherein one of the plurality of engine parameters comprises a sensor status.

17. The method of claim 16, wherein the sensor comprises one of a temperature sensor and a knock sensor.

18. The method of claim 16, wherein the adjusting comprises ceasing the quantity of the first fuel into the first engine cylinder.

19. A method for operating an engine, comprising:
introducing a first fuel, a second fuel and an oxidant into a first engine cylinder;
monitoring a plurality of engine parameters;
increasing a quantity of the second fuel introduced in the first engine cylinder based on one of the plurality of monitored engine parameters; and
reducing a quantity of the first fuel introduced in the first engine cylinder based on one of the plurality of monitored engine parameters, in response to an increased load operation of the engine.

20. The method of claim 19, wherein the increased load operation of the engine comprises a transient acceleration operation.

21. The method of claim 19, wherein the quantity of the first fuel is decreased to be in a range of from about 70% to about 50% of total energy content in the first engine cylinder, and wherein the quantity of the second fuel is increased to be in a range of from 30% to about 50% of the total energy content in the first engine cylinder.

22. The method of claim 19, further comprising introducing a first fuel, a second fuel and an oxidant into a second engine cylinder.

23. The method of claim 22, further comprising adjusting a quantity of one of the first fuel, the second fuel and the oxidant introduced to the second engine cylinder to be different from a quantity of one of the first fuel, the second fuel, and the oxidant introduced to the first engine cylinder

24. The method of claim 22, wherein the quantity of the first fuel in the second engine cylinder is greater than the quantity of the first fuel in the first engine cylinder, and wherein the quantity of the second fuel in the second engine cylinder is smaller than the quantity of the second fuel in the first engine cylinder in response to the increased load operation of the engine.

25. The method of claim 19, wherein introducing comprises introducing a pre-mixture of the first fuel and the oxidant into the first engine cylinder during an intake stroke thereof and introducing the second fuel into the first engine cylinder during a compression stroke thereof.

26. The method of claim 19, wherein the first fuel comprises a gaseous fuel and wherein the second fuel comprises a liquid fuel.

27. The method of claim 19, wherein the first fuel comprises natural gas, wherein the second fuel comprises diesel, and wherein the oxidant comprises air.

28. The method of claim 19, wherein one of the plurality of engine parameters comprises engine speed, an aftertreatment status, a sensor status, and engine load.

29. A method for operating an engine, comprising:
introducing a first fuel, a second fuel and an oxidant into a first engine cylinder set and a second engine cylinder set;
monitoring a plurality of engine parameters;
increasing a quantity of the second fuel and reducing a quantity of the first fuel in the first engine cylinder set in response to an increased load operation of the engine; and
adjusting a quantity of one of the first fuel, the second fuel and the oxidant introduced to the second engine cylinder set to be different from a quantity of one of the first fuel, the second fuel, and the oxidant introduced to the first engine cylinder set.

30. The method of claim 29, wherein the increased load operation of the engine comprises a transient acceleration operation.

31. The method of claim 30, wherein the quantity of the second fuel is increased to be in a range of from 30% to about 50% of total energy content in the first engine cylinder, and wherein the quantity of the first fuel is decreased to be in a range of from about 70% to about 50% of total energy content in the first engine cylinder.

32. The method of claim 30, wherein the quantity of the first fuel in the second engine cylinder is greater the quantity of the first fuel in the first engine cylinder, and wherein the quantity of the second fuel in the second engine cylinder is smaller than the quantity of the second fuel in the first engine cylinder in response to the increased load operation of the engine.

33. The method of claim 30, wherein introducing comprises introducing a pre-mixture of the first fuel and the oxidant into the first engine cylinder during an intake stroke thereof and introducing the second fuel into the first engine cylinder during a compression stroke thereof, and wherein the pre-mixture is lean.

34. The method of claim 29, wherein the first fuel comprises a gaseous fuel and wherein the second fuel comprises a liquid fuel.

35. The method of claim 29, wherein the first fuel comprises natural gas, wherein the second fuel comprises diesel, and wherein the oxidant comprises air.

36. A method of operating an internal combustion engine, said internal combustion engine comprising a first cylinder set and a second cylinder set, the method comprising:
introducing a first fuel, a second fuel, and an oxidant into the first cylinder set, thereby defining a first substitution rate;
introducing a first fuel, a second fuel, and an oxidant into the second cylinder set, thereby defining a second substitution rate;
monitoring at least one engine parameter; and
adjusting the first substitution rate to a third substitution rate in at least one cylinder of the first cylinder set, in response to the monitoring, wherein the third substitution rate is different than the second substitution rate.

37. The method of claim 36, wherein the third substitution rate is less than the first substitution rate.

38. The method of claim 36, wherein the first cylinder set comprise non-donor cylinders.

39. The method of claim 36, wherein the adjusting comprises adjusting the first substitution rate to a third substitution rate in all the cylinders of the first cylinder set.

40. The method of claim 39, wherein the adjusting comprises adjusting the first substitution rate to a third substitution rate in less than all the cylinders of the first cylinder set.

41. The method of claim 40, wherein the adjusting comprises adjusting the first substitution rate to a third substitution rate in only one of the cylinders of the first cylinder set.

42. The method of claim 40, wherein the third substitution rate comprises no first fuel.

43. The method of claim 36, wherein the first cylinder set comprises at least one donor cylinder and the second cylinder set comprises at least one non-donor cylinder, further wherein the third substitution rate is greater than the first substitution rate.

44. The method of claim 43, wherein the adjusting is further in response to one of an ambient temperature and an exhaust temperature.

45. The method of claim 44, further comprising one of:
advancing timing in the first cylinder set; and
retarding timing in the second cylinder set.
